(19) United States
(12) Patent Application Publication
(10) Pub. No.: US 2012/0147247 A1
(43) Pub. Date: Jun. 14, 2012

(54) OPTICAL SYSTEM AND IMAGING APPARATUS INCLUDING THE SAME

(75) Inventors: Norimitsu ANADA, Yokohama-shi (JP); Jiro Funakura, Yokohama-shi (JP); Yasuhiro Morimoto, Yokohama-shi (JP); Mitsuhiro Togashi, Yokohama-shi (JP)

(73) Assignee: Samsung Electronics Co., Ltd., Gyeonggi-do (KR)

(21) Appl. No.: 13/325,829

(22) Filed: Dec. 14, 2011

(30) Foreign Application Priority Data
Dec. 14, 2010 (JP) 278119/2010
Nov. 23, 2011 (KR) 10-2011-0122830

(51) Int. Cl. H04N 5/225; G02B 27/12

(52) U.S. Cl. 348/335; 359/619; 348/E05.024

(57) ABSTRACT

An optical system is provided. The system includes a lens having a negative refractive power to which light is incident from an imaging target object; a compound eye optical element; and an imaging device for receiving the light passing through the lens and the compound eye optical element, wherein the compound eye optical element includes a plurality of optical elements to which the light passing through the lens is incident.

### PRIORITY

This application claims priority under 35 U.S.C. §119(a) to a Patent Application filed in the Japan Patent Office on Dec. 14, 2010 and assigned Serial No. 278119/2010, and a Patent Application filed in the Korean Intellectual Property Office on Nov. 23, 2011 and assigned serial No. 10-2011-0122830, the entire disclosures of which are incorporated herein by reference.

### BACKGROUND OF THE INVENTION

1. Field of the Invention

The present invention relates generally to an optical system and an imaging apparatus including the optical system.

2. Description of the Related Art

Presently, digital cameras, video cameras, and the like are used as imaging apparatuses for acquiring various image information. An imaging apparatus acquires an image of an object by using a single optical system facing the object. However, the imaging apparatus with the single optical system cannot obtain image information such as parallax information. Accordingly, an imaging apparatus using a compound eye (or fly's eye) image forming optical system capable of combining a free-viewpoint image or multi focal image based on image information including parallax information has been developed.

For an example of the compound eye-type imaging apparatus, Japanese Patent Laid-Open Publication No. 2001-61109 discloses an imaging apparatus using a lens array. Further, U.S. Pat. No. 5,076,687 discloses an optical ranging apparatus which combines a lens array with a lens having a positive refractive power and divides views while providing view overlap between a plurality of images of an object photographed by each lens included in the lens array.

In U.S. Pat. No. 5,076,687, when the view overlap between adjacent images of the object is provided, parallax decreases, thereby deteriorating the resolution of the image of the object.

### SUMMARY OF THE INVENTION

Accordingly, an aspect of the present invention is to solve the above-stated problems occurring in the prior art, and to provide an optical system and an imaging apparatus including the optical system capable of making the optical system be small, and increasing the parallax to obtain an image with improved resolution.

In accordance with an aspect of the present invention, an optical system is provided. The optical system includes a negative refractive power lens incident to light from an imaging target object; a compound eye optical element; and an imaging device for receiving the light passing through the negative refractive power lens and the compound eye optical element, wherein the compound eye optical element includes a plurality of optical elements incident to the light passing through the negative refractive power lens.

In accordance with another aspect of the present invention, an imaging apparatus is provided. The apparatus includes a negative refractive power lens incident to light from an imaging target object; a compound eye optical element; an optical system including an imaging device for receiving the light from the imaging target object passing through the negative refractive power lens and the compound eye optical element; and a processor for processing the light of the imaging target object received in the imaging device and forming an image of the imaging target object, wherein the compound eye optical element includes a plurality of optical elements incident to the light from the imaging target object passing through the negative refractive power lens.

In accordance with another aspect of the present invention, a method of imaging is provided. The method includes receiving, by an imaging device, light passing through a negative refractive power lens and compound eye optical element, wherein the negative refractive power lens is incident to light from an imaging target object, and wherein the compound eye optical element includes a plurality of optical elements to which the light passing through the negative refractive power lens is incident.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates an optical system according to an embodiment of the present invention;

FIG. 2 illustrates the construction of an optical system according to an embodiment of the present invention;

FIG. 3 illustrates a construction of an optical system according to an embodiment of the present invention;

FIG. 4A illustrates an optical system using a lens array; and

FIG. 4B illustrates an optical system using a lens having a positive refractive power and a lens array.

### DETAILED DESCRIPTION OF EMBODIMENTS OF THE PRESENT INVENTION

An embodiment of the present invention will now be described in detail with reference to the accompanying drawings. Further, the present invention is not limited to the following embodiment and may be implemented in multiple ways without departing from the principles of the present invention.

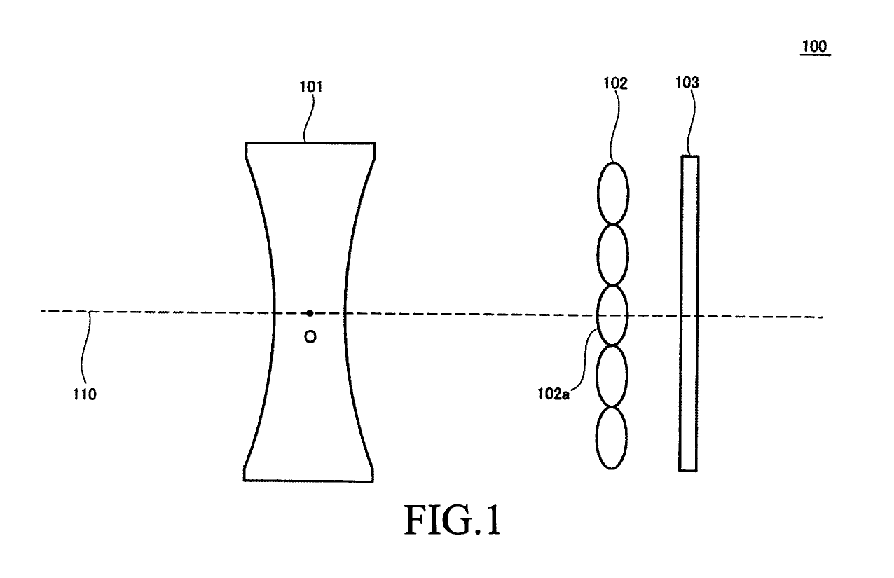

FIG. 1 illustrates an optical system 100 according to an embodiment of the present invention. The optical system 100 according to the embodiment of the present invention illustrated in FIG. 1 includes a negative refractive power lens 101, a compound eye optical element 102 positioned in the rear of lens 101 as viewed from an imaging target object, and an imaging device 103 positioned at a rear side of the compound eye optical element 102 as viewed from a position of the imaging target object.

A biconcave lens illustrated in FIG. 1 or a lens having at least one concave optical surface between two optical surfaces meeting an optical axis 110 may be used as the lens 101. Further, at least one of the two optical surfaces of the lens 101 may be an aspheric surface, or one of the two optical surfaces of the lens 101 may be a plane surface. The lens 101 may include a plurality of lenses which are combined to form a lens group having a negative refractive power. The compound eye optical element 102 is an optical element including a plurality of optical surfaces, and the compound eye optical element 102 is positioned on the optical axis 110. Generally, the optical axis refers to an axis which is not optically changed even if a corresponding optical system is rotated with respect to the axis. The arrangement on an optical axis refers to that a center of a curvature of an optical element included in a corresponding optical system is located on the optical axis, or a symmetric point (i.e. the center of symmetry) or a center point of an optical element is located on the optical axis.

FIG. 1 illustrates that compound eye optical element 102 is configured with an array of a plurality of optical elements 102a, each having a positive refractive power. Further, the compound eye optical element 102 may be a one-piece lens array or a lens group including individual lenses. Each of the plurality of optical elements 102a may be a biconvex lens or a lens having at least one convex optical surface between two optical surfaces of the lens. Further, at least one of the two optical surfaces of the optical element 102a may be an aspheric surface, or one of the two optical surfaces of the optical element 102a may be a plane surface. The plurality of optical elements 102a are symmetrically positioned relative to the optical axis 110. The imaging device 103 includes a plurality of light receiving elements (not shown), and the plurality of light receiving elements are positioned on a surface of the imaging device 103. The plurality of light receiving elements of the imaging device 103 receive light incident to the lens 101 and pass through the lens 101 and the compound eye optical element 102.

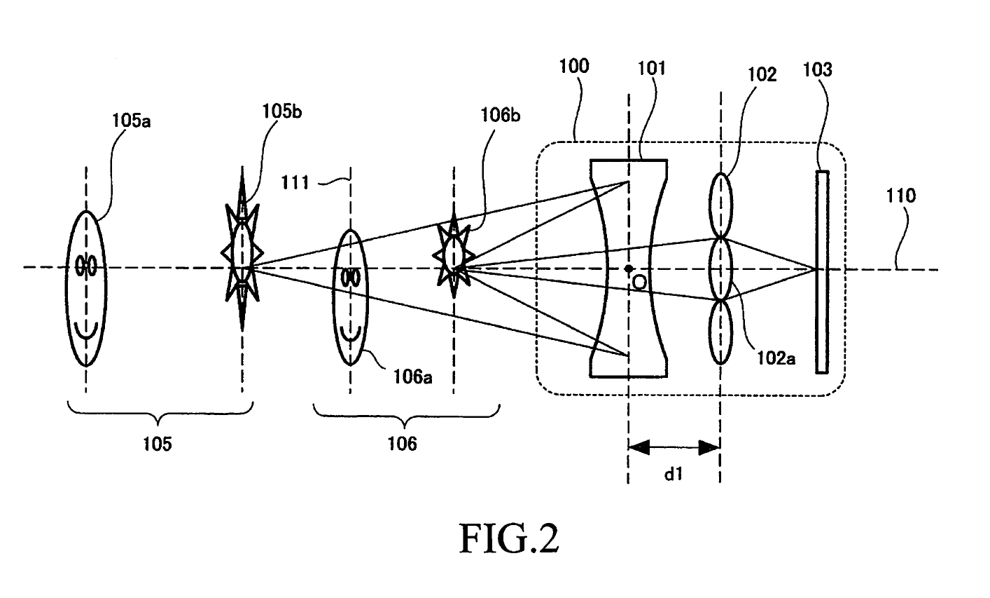

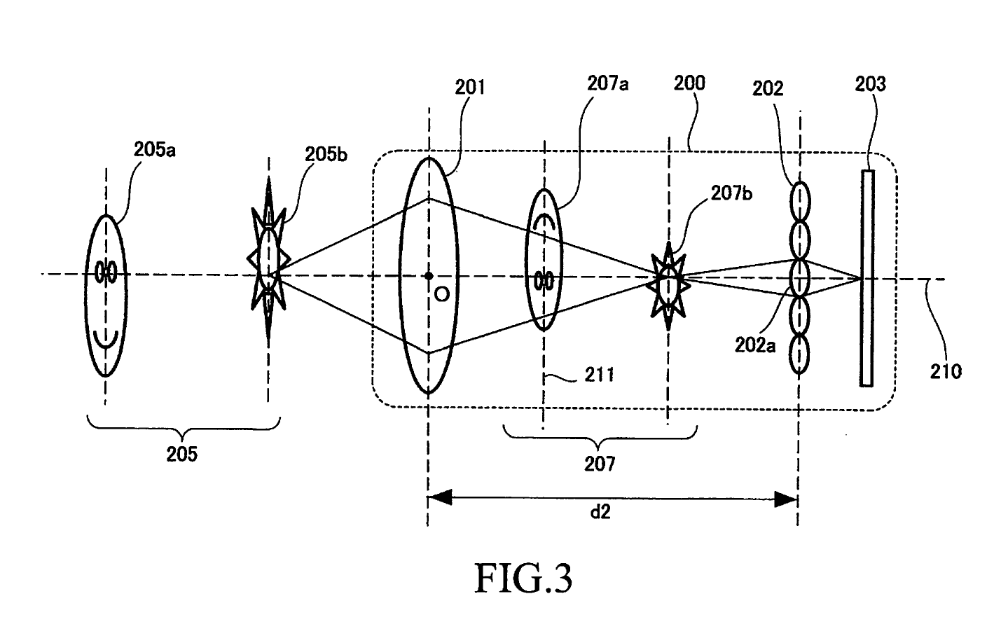

The construction of the optical system 100, according to the embodiment of the present invention, will be described with reference to FIGS. 2 and 3 in greater detail. FIG. 2 illustrates an example of the construction of the optical system 100 according to the embodiment of the present invention and FIG. 3 illustrates another example of the optical system 100 according to the embodiment of the present invention.

FIG. 2 illustrates an example of imaging of an imaging target object 105 by the optical system 100 illustrated in FIG. 1. The present invention is described with an example that imaging target object 105 includes a first object 105a at infinity in the front of the lens 101 and a second object 105b positioned close to the lens 101. 10 When light from the imaging target object 105 is incident to the lens 101, a virtual image 106 of the imaging target object 105 is formed in the front (i.e., the left side of the lens 101 in FIG. 2) of the lens 101 as viewed from the imaging target object 105. The virtual image of the first object 105a is a first virtual image 106a, and the virtual image of the second object 105b is a second virtual image 106b. As illustrated in FIGS. 2 and 3, the first virtual image 106a is formed at a focal plane 111 of the lens 101 and the second virtual image 106b is formed at a predetermined position which is in the rear of the focal plane 111 and front of the lens 101.

The virtual image 106 is formed on the light receiving elements of the imaging device 103 through the plurality of optical elements 102a included in the compound eye optical element 102 as an image of the imaging target object 105. An image formed by the single optical element 102a is a single-eye image and a set of single-eye images of the entire compound eye optical element 102 is a compound-eye image. A plurality of compound-eye images is image data of a decreased image of the imaging target object 105 obtained from multiple viewpoints or directions depending on the number of optical elements 102a. Accordingly, the compound-eye image that is the set of the single-eye images includes distance information and direction information of the imaging target object 105. Accordingly, by image-processing the image data of the plurality of single-eye images using an image processing means such as a computer, a high resolution image of the imaging target object 105 can be obtained. By processing the image data of the plurality of single-eye images with an image processing means (not shown) connected to the imaging device 103, a single image of the imaging target object 105 may be obtained. Moreover, by processing the image data including distance information and direction information of each of the plurality of single-eye images with the image processing means, an image of the imaging target object 105 with a focus on a predetermined position may be formed. It is possible to adjust the focus of the image again after photographing of the imaging target object 105 or estimate a distance to the imaging target object 105 through image processing.

The construction of an optical system 200, which is another example of the construction of the optical system 100 according to the embodiment of the present invention as illustrated in FIGS. 1 and 2 will be described with reference to FIG. 3. The optical system 200 includes a lens 201 having a positive refractive power, a compound eye optical element 202 positioned in the rear of the lens 201 as viewed from an imaging target object 205, and an imaging device 203 positioned in the rear of the compound eye optical element 202 as viewed from an imaging target object 205. The optical system 200 illustrated in FIG. 3 is different from the optical system 100 illustrated in FIG. 2 in that, in FIG. 2, the lens 201 has a negative refractive power while in FIG. 3, the lens 201 has a positive refractive power. A biconvex lens illustrated in FIG. 3 or a lens having at least one convex optical surface between two optical surfaces meeting an optical axis 210 may be used as the lens 201. Further, at least one of the two optical surfaces of the lens 201 may be an aspheric surface, or one of the two optical surfaces of the lens 201 may be a plane surface. The lens 201 may include a plurality of lenses which are combined to form a lens group having a positive refractive power.

When light from the imaging target object 205 is incident to the lens 201 positioned in the front of the lens 201, a real image 207 of the imaging target object 205 is formed between the lens 201 and the compound eye optical element 202. The imaging target object 205 includes a first object 205a at infinity and a second object 205b positioned in an adjacent position to first object 205a. The real image 207 includes a first real image 207a of the first object 205a and a second real image 207b of the second object 205b. As illustrated in FIG. 3, the first real image 207a of the first object 205a at infinity is formed on a focal plane 211 between the lens 201 and the compound eye optical element 202. Moreover, the second real image 207b of the adjacent second object 205b is formed at a position which is the rear of the focal plane 211 of the lens 201 and the front of the compound eye optical element 202.

Comparing optical system 100 of FIG. 2 and the optical system 200 of FIG. 3, in the optical system 100, since the position where the virtual image 106 of the imaging target object 105 is formed is at the front of the optical system 100 as viewed from the imaging target object 105, a distance d1 between the lens 101 and the compound eye optical element 102 may be decreased. However, in the optical system 200 of FIG. 3, since the position where the real image 207 of the imaging target object 205 is formed is between the lens 201 and the compound eye optical element 202 included in the optical system 200, distance d2 between the lens 201 and the compound eye optical element 202 must be longer than the distance d1 between the lens 101 and the compound eye optical element 102 of the optical system 100 according to the embodiment of the present invention. Thus, the optical system 100 of FIG. 2 can make the distance dl between the lens 101 and the compound eye optical system 102 be shorter than the distance d2 between the lens 201 and the compound eye optical element 202 of the comparative example of the optical system 200 of FIG. 3, thereby making the entire length of the optical system shorter. Accordingly, the present invention can achieve a smaller size of the optical system 100.

Furthermore, as compared to the optical system 200 of FIG. 3, the optical system 100 of FIG. 2 may increase a distance from the position where the virtual image 106 of the imaging target object 105 is formed to the compound eye optical element 102 by using the lens 101 having the negative refractive power, thereby increasing lateral magnification of an image formed at the imaging device 103 and increasing parallax. Further, the optical system 100 may provide view overlap of the plurality of single-eye images, so that an imaging range of each of the plurality of optical elements 102a may have a common range. Further, a common imaging range between the adjacent single-eye images is at least 50% of the imaging range. That is, through the optical system 100, it is possible to obtain a plurality of single-eye images with at least 50% of view overlap. Each of the plurality of single-eye images has at least 50% of view overlap with all other single-eye images. Accordingly, the optical system 100 according to the embodiment of the present invention may increase the degree of precision in detection of parallax, thereby obtaining an image of the imaging target object 105 with improved resolution.

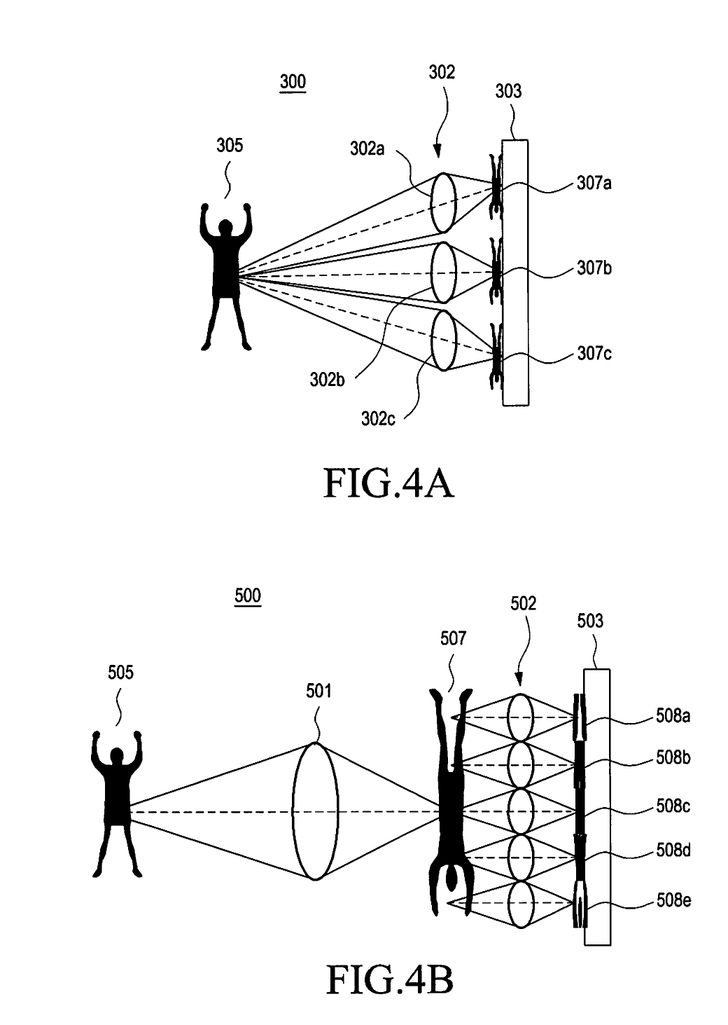

Hereinafter, the optical system 100 according to the embodiment of the present invention will be compared with a comparative example of an optical system with reference to FIGS. 4A and 4B. FIGS. 4A and 4B illustrate a construction of the optical system according to another, and FIG. 4A illustrates an example of the optical system using a lens array and FIG. 4B illustrates an example of the optical system using a lens having a positive refractive power and a lens array.

Referring to FIG. 4A, an optical system 300 includes a lens array 302 and an imaging device 303 positioned in the rear of the lens array 302 as viewed from an imaging target object 305. The imaging target object 305 is positioned in the front of the lens array 302, and decreased images of the imaging target object 305 are formed on a light receiving element of the imaging device 303 in the form of actual images 307a, 307b and 307c through each of the lenses 302a, 302b and 302c in the lens array 302.

According to the optical system 300, when the imaging target object 305 is positioned at a long distance from the optical system 300, a distance from the lens array 302 to the imaging target object 305 is long, so that parallax is decreased. In the optical system 100, the lens 101, which has a negative refractive power is positioned in the front of the compound eye optical element 102, so that it is possible to shorten the distance from the position at which the virtual image 106 of the imaging target object 105 is formed to the compound eye optical system 102 as compared to the optical system 300 of FIG. 4A and thus increase the parallax. Therefore, the optical system 100 can obtain an image of the imaging target object 105 with improved resolution compared to the optical system 300 of FIG. 4A.

Referring to FIG. 4B, the optical system 500 includes a lens 501 having a positive refractive power, a lens array 502 positioned in the rear of the lens 501 as viewed from an imaging target object 505, and an imaging device 503 in the rear of the lens array 502 as viewed from the imaging target object 505. The imaging target object 505 is positioned in the front of the lens 501, and a real image 507 of the imaging target object 505 is formed between the lens 501 and the lens array 502. The lens array 502 includes a plurality of micro lenses, and the real image 507 is formed on the imaging device 503 of single-eye images 508a to 508e through each micro lens. Each of the plurality of single-eye images 508a to 508e formed on the imaging device 503 is a part of a decreased image of the imaging target object 505.

As described above, according to the optical system 500, when the real image 507 is formed between the lens 501, which is an object lens, and the lens array 502, the entire length of the optical system increases. Furthermore, although not illustrated, when the real image 507 formed in the rear of the imaging device 503 is to be formed on the imaging device 503, it is possible to reduce the entire length of the optical system. However, if it is desired to provide view overlap of the plurality of adjacent single-eye images 508a to 508e, parallax is decreased, thereby deteriorating resolution of an image of the imaging target object 505. Further, when the number of micro lenses is decreased, because it is necessary to increase a focal distance of the micro lens in order to provide view overlap between the adjacent micro lenses, the entire length of the optical system is increased.

In the optical system 100, the position where the virtual image 106 of the imaging target object 105 is formed is the front of the lens 101, as viewed from the imaging target object 105, so that it is possible to reduce the entire length of the optical system, thereby achieving the small size of the optical system 100. Further, the optical system 100 can acquire image data of the plurality of single-eye images that are the decreased images of the imaging target object 105 obtained from multiple viewpoints and directions depending on the number of optical elements 102a. Further, the optical system 100 can provide view overlap between the plurality of single-eye images, so that an imaging range of each of the plurality of optical elements 102a may have a common range. Further, a common imaging range between the adjacent single-eye images is at least 50% of the imaging range. Each of the plurality of single-eye images has at least 50% of a view overlap with all other single-eye images. Therefore, through the imaging processing of the image data of the plurality of single-eye images with at least 50% of view overlap, the optical system 100 can obtain an image of the imaging target object 105 with improved resolution. Further, as compared to the optical system 500 using the lens having the positive refractive power, since the optical system 100 can increase a distance from the position where the virtual image 106 of the imaging target object is formed to the compound eye optical element 102, it is possible to increase lateral magnification of an image formed on the imaging device 103 and increase parallax. Accordingly, even compared to the optical system 500 of FIG. 4B, the optical system 100 according to the embodiment of the present invention can improve a degree of precision in detection of parallax, thereby obtaining an image of the imaging target object 105 with improved resolution.

As described above, the present invention can provide the optical system 100 and the imaging apparatus including the optical system 100 capable of making the optical system 100 be small, and increasing parallax to obtain an image with improved resolution.

Further, the optical system 100 according to the embodiments of the present invention can be applied to an optical system and an imaging apparatus used in various electronic devices including a digital camera, a video camera, and a mobile phone.

As described above, the optical system and the imaging apparatus including the optical system according to the embodiments of the present invention can make the optical system be small, and increase parallax to obtain an image with improved resolution.

While the present invention has been shown and described with reference to certain embodiments and drawings of the portable terminal, it will be understood by those skilled in the art that various changes in form and details may be made therein without departing from the spirit and scope of the invention as defined by the appended claims and their equivalents.

What is claimed is:

1. An optical system, the system comprising:
a lens having a negative refractive power to which light is incident from an imaging target object;
a compound eye optical element; and
an imaging device for receiving the light passing through the lens and the compound eye optical element,
wherein the compound eye optical element includes a plurality of optical elements to which the light passing through the lens is incident.

2. The optical system of claim 1, wherein each of the plurality of optical elements has a common imaging range.

3. The optical system of claim 2, wherein the common imaging range is at least 50% of an imaging range for each of the plurality of optical elements.

4. The optical system of claim 1, wherein the lens includes a biconcave lens.

5. The optical system of claim 1, wherein each of the plurality of optical elements includes a biconvex lens.

6. An imaging apparatus, the apparatus comprising:
a lens having a negative refractive power to which light from an imaging target object is incident;
a compound eye optical element;
an optical system including an imaging device for receiving the light from the imaging target object passing through the lens and the compound eye optical element; and
a processor for processing the light of the imaging target object received in the imaging device and forming an image of the imaging target object,
wherein the compound eye optical element includes a plurality of optical elements to which the light from the imaging target object passing through the lens is incident.

7. The imaging apparatus of claim 6, wherein each of the plurality of optical elements has a common imaging range.

8. The imaging apparatus of claim 7, wherein the common imaging range is at least 50% of an imaging range for each of the plurality of optical elements.

9. The imaging apparatus of claim 6, wherein the lens includes a bi concave lens.

10. The imaging apparatus of claim 6, wherein each of the plurality of optical elements includes a biconvex lens.

11. A method of imaging, the method comprising:
receiving, by an imaging device, light passing through a lens having a negative refractive power and a compound eye optical element from an imaging target object,
wherein the light from the imaging target object is incident to the lens, and
wherein the compound eye optical element includes a plurality of optical elements to which the light passing through the lens is incident.

12. The method of imaging of claim 11, wherein each of the plurality of optical elements has a common imaging range.

13. The method of imaging of claim 12, wherein the common imaging range is at least 50% of an imaging range for each of the plurality of optical elements.

14. The method of imaging of claim 11, wherein the lens includes a bi-concave lens.

15. The method of imaging of claim 11, wherein each of the plurality of optical elements includes a biconvex lens.
